(19) United States
(12) Patent Application Publication
(10) Pub. No.: US 2009/0300519 A1
(43) Pub. Date: Dec. 3, 2009

(54) CONFERENCE SYSTEM, DATA PROCESSING APPARATUS, IMAGE TRANSMISSION METHOD, AND IMAGE TRANSMISSION PROGRAM EMBODIED ON COMPUTER READABLE MEDIUM

(75) Inventors: Daisuke Sakiyama, Kawani-shi (JP); Mitsuzo Iwaki, Osaka-shi (JP); Kenichi Takahashi, Sennan-gun (JP); Takeshi Minami, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/394,311

(22) Filed: Feb. 27, 2009

(30) Foreign Application Priority Data
Jun. 2, 2008 (JP) 2008-144450

(51) Int. Cl. G06F 3/00

(52) U.S. Cl. 715/753

(57) ABSTRACT

In order to facilitate understanding of the content of a presentation in a conference, an MFP, in receipt of presentation page information from a PC operated by a presenter, transmits presentation page data specified by the presentation page information among page data for a plurality of pages included in data to PCs operated by the participants, and in receipt of requested page information from a specific participant apparatus among the PCs operated by the participants, transmits requested page data specified by the requested page information to the specific participant apparatus. As to the PC as the specific participant apparatus, upon acceptance of designation of requested page data, it transmits requested page information to the MFP, and in receipt of the requested page data from the MFP, displays an image of the presentation page data and an image of the requested page data simultaneously.

This application is based on Japanese Patent Application No. 2008-144450 filed with Japan Patent Office on Jun. 2, 2008, the entire content of which is hereby incorporated by reference.

### BACKGROUND OF THE INVENTION

1. Field of the Invention

The present invention relates to a conference system, a data processing apparatus, an image transmission method, and an image transmission program. More particularly, the present invention relates to a conference system, a data processing apparatus, an image transmission method, and an image transmission program embodied on a computer readable medium, for transmitting an image of a document used for presentation in a conference and the like.

2. Description of the Related Art

In a conference and the like, images of a document for explanation are displayed on a screen during presentation. In recent years, it is often the case that, with the document stored in a computer, a projector or another display device is connected to the computer to display the document images output from the computer.

A participant who came late at the conference may wish to know the content the participant missed. For example, Japanese Patent Application Laid-Open No. 2000-092217 discloses an electronic conference system wherein in a computer used by a user who is not a speaker or presenter at a conference, a display mode is switched between a shared mode, in which the same content as displayed on the presenter's computer is displayed on the user's computer in a synchronous manner, and an independent mode, in which arbitrary information other than the information displayed on the presenter's computer is displayed on the user's computer.

With the above-described system, the user can see the content other than the one being presented by the presenter at that time by switching the user's computer to the independent mode. However, because the content is displayed independently of the content being presented by the presenter, it is not possible to associate the content being displayed with the content being presented from only the screen displayed on the computer. This makes it difficult for the user to understand the content of the presentation.

### SUMMARY OF THE INVENTION

The present invention has been accomplished in view of the foregoing problems, and an object of the present invention is to provide a conference system which facilitates understanding of the content of the presentation in a conference.

Another object of the present invention is to provide a data processing apparatus which facilitates understanding of the content of the presentation in a conference.

A further object of the present invention is to provide an image transmission method which facilitates understanding of the content of the presentation in a conference.

Yet another object of the present invention is to provide an image transmission program which facilitates understanding of the content of the presentation in a conference.

In order to achieve the above-described objects, according to an aspect of the present invention, a conference system includes a plurality of display apparatuses and a data processing apparatus operatively connectable with the plurality of display apparatuses, the display apparatuses including a presenter apparatus operated by a presenter and one or more participant apparatuses other than the presenter apparatus operated by corresponding one or more participants, wherein the data processing apparatus includes: a data obtaining portion to obtain data including page data for a plurality of pages; a presentation page receiving portion to receive, from the presenter apparatus, presentation page information for identification of one of the page data for the plurality of pages included in the obtained data; a presentation page transmitting portion to extract presentation page data specified by the received presentation page information from among the page data for the plurality of pages included in the data and transmit the extracted presentation page data to the one or more participant apparatuses; a requested page receiving portion to receive, from a specific participant apparatus among the one or more participant apparatuses, requested page information for identification of one of the page data for the plurality of pages included in the obtained data; and a requested page transmitting portion, in response to reception of the requested page information, to extract requested page data specified by the requested page information from among the page data for the plurality of pages included in the data and transmit the extracted requested page data to the specific participant apparatus; and wherein the plurality of display apparatuses each include: a designation accepting portion to accept designation of the requested page data; a requesting portion to transmit the requested page information for identification of the designated requested page data to the data processing apparatus; and a display control portion, in response to reception of the requested page data, to display an image of the presentation page data and an image of the requested page data at the same time.

According to another aspect of the present invention, a data processing apparatus is operatively connectable with a plurality of display apparatuses including a presenter apparatus operated by a presenter and one or more participant apparatuses other than the presenter apparatus operated by corresponding one or more participants, and includes: a data obtaining portion to obtain data including page data for a plurality of pages; a presentation page receiving portion to receive, from the presenter apparatus, presentation page information for identification of one of the page data for the plurality of pages included in the obtained data; a first transmitting portion to transmit a first screen including an image of presentation page data specified by the received presentation page information among the page data for the plurality of pages included in the data to the one or more participant apparatuses; a requested page receiving portion to receive, from a specific participant apparatus among the one or more participant apparatuses, requested page information for identification of one of the page data for the plurality of pages included in the obtained data; a screen generating portion, in response to reception of the requested page information, to generate a second screen including an image of the requested page data specified by the requested page information among the page data for the plurality of pages included in the data and the image of the presentation page data specified by the presentation page information; and a second transmitting portion to transmit the generated second screen to the specific participant apparatus.

According to a further aspect of the present invention, an image transmission method includes the steps of: obtaining data including page data for a plurality of pages; receiving, from a presenter apparatus among a plurality of display apparatuses, presentation page information for identification of one of the page data for the plurality of pages included in the obtained data; transmitting, to one or more participant apparatuses other than the presenter apparatus among the plurality of display apparatuses, a first screen including an image of presentation page data specified by the received presentation page information among the page data for the plurality of pages included in the data; receiving, from a specific participant apparatus among the one or more participant apparatuses, requested page information for identification of one of the page data for the plurality of pages included in the obtained data; in response to reception of the requested page information, generating a second screen including an image of requested page data specified by the requested page information among the page data for the plurality of pages included in the data and the image of the presentation page data specified by the presentation page information; and transmitting the generated second screen to the specific participant apparatus.

According to yet another aspect of the present invention, an image transmission program embodied on a computer readable medium causes a computer to carry out the steps of: obtaining data including page data for a plurality of pages; receiving, from a presenter apparatus among a plurality of display apparatuses, presentation page information for identification of one of the page data for the plurality of pages included in the obtained data; transmitting, to one or more participant apparatuses other than the presenter apparatus among the plurality of display apparatuses, a first screen including an image of presentation page data specified by the received presentation page information among the page data for the plurality of pages included in the data; receiving, from a specific participant apparatus among the one or more participant apparatuses, requested page information for identification of one of the page data for the plurality of pages included in the obtained data; in response to reception of the requested page information, generating a second screen including an image of requested page data specified by the requested page information among the page data for the plurality of pages included in the data and the image of the presentation page data specified by the presentation page information; and transmitting the generated second screen to the specific participant apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a conference system according to an embodiment of the present invention.

FIG. 2 is a perspective view of an MFP.

FIG. 3 is a block diagram showing an example of the hardware configuration of the MFP.

FIG. 4 is a block diagram showing an example of the hardware configuration of a PC.

FIG. 5 is a functional block diagram showing an example of the functions of a CPU included in the MFP.

FIG. 6 shows an example of a presentation setting screen.

FIG. 7 shows an example of presentation data.

FIG. 8 shows an example of a presentation operation screen.

FIG. 9 is a functional block diagram schematically showing the functions of a CPU included in the PC.

FIGS. 10A and 10B each show an example of a viewer screen.

FIG. 11 is a flowchart illustrating an example of the flow of display control processing performed in the MFP.

FIG. 12 is a flowchart illustrating an example of the flow of display control processing performed in the PC.

FIG. 13 is a flowchart illustrating an example of the flow of printing control processing performed in the PC.

FIG. 14 is a functional block diagram schematically showing the functions of a CPU included in the MFP according to a modification.

FIG. 15 is a flowchart illustrating an example of the flow of display control processing performed by the CPU included in the MFP in the modification.

FIG. 16 is a flowchart illustrating an example of the flow of first viewer screen generating processing.

FIG. 17 is a flowchart illustrating an example of the flow of second viewer screen generating processing.

### DESCRIPTION OF THE PREFERRED EMBODIMENTS

Embodiments of the present invention will now be described with reference to the drawings. In the following description, like reference characters denote like members, which have like names and functions, and therefore, detailed description thereof will not be repeated.

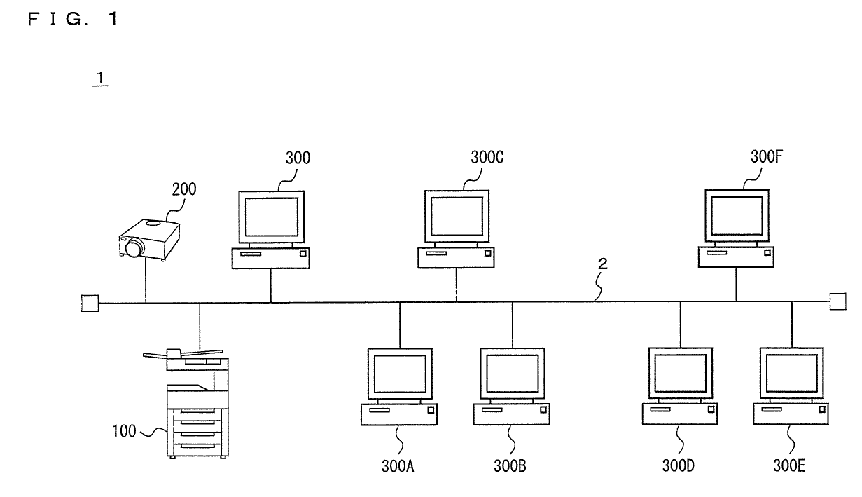

FIG. 1 schematically shows a conference system according to an embodiment of the present invention. Referring to FIG. 1, a conference system 1 includes an MFP (Multi Function Peripheral) 100 serving as a data processing apparatus, a projector 200, and a plurality of personal computers (hereinafter, referred to as “PCs”) 300 and 300A to 300F serving as display apparatuses, which are each connected to a network 2. Here, it is assumed that a presenter at a conference operates PC 300 to display a document on projector 200, while participants in the conference operate PCs 300A to 300F to view the document.

Network 2 is a local area network (LAN), which may be connected in a wired or wireless manner. Network 2 is not necessarily the LAN; it may be a wide area network (WAN), public switched telephone networks (PSTN), the Internet, and the like.

While the case where one conference room is used for presentation is described here, the participants may be in different spaces physically distant from each other. In such a case, in addition to projector 200, another projector is arranged in each space physically distant from the space where projector 200 is disposed, to display the same images as those displayed on projector 200. This technique is well known as the “television conference system”. Still alternatively, the images of the contents of the presentation may be displayed only on the displays included in the participants' PCs 300A to 300F, without the use of projector 200.

Projector 200 is capable of communicating with MFP 100 via network 2, and displays the images received from MFP 100. Projector 200 includes a liquid crystal display, a lens, and a light source, and displays externally input data. The light emitted from the light source transmits through the liquid crystal display, and is externally emitted via the lens. When the light emitted from the projecting portion reaches a screen, a magnified version of the image displayed on the liquid crystal display is thrown onto the screen. It is noted that a wall having a highly reflective surface may be used instead of the screen, in which case installation of the screen is unnecessary. While projector 200 is described by way of example, it may be replaced with a display such as a liquid crystal display (LCD) or an organic electro-luminescence display (ELD).

PCs 300 and 300A to 300F are typical computers, each having an application program for communicating with MFP 100 installed therein.

MFP 100 includes a scanner device for reading an original, and an image forming device and a facsimile device for forming an image on a recording medium such as a sheet of paper based on image data, and has the image reading function, copying function, and facsimile transmitting/receiving function. While MFP 100 is described as an example of the image transmission apparatus in the present embodiment, not limited to MFP 100, the image transmission apparatus may be a scanner, printer, facsimile machine, computer, or other device capable of recording still images.

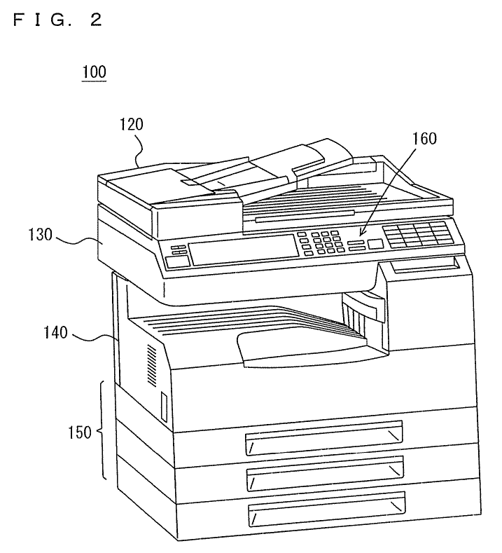

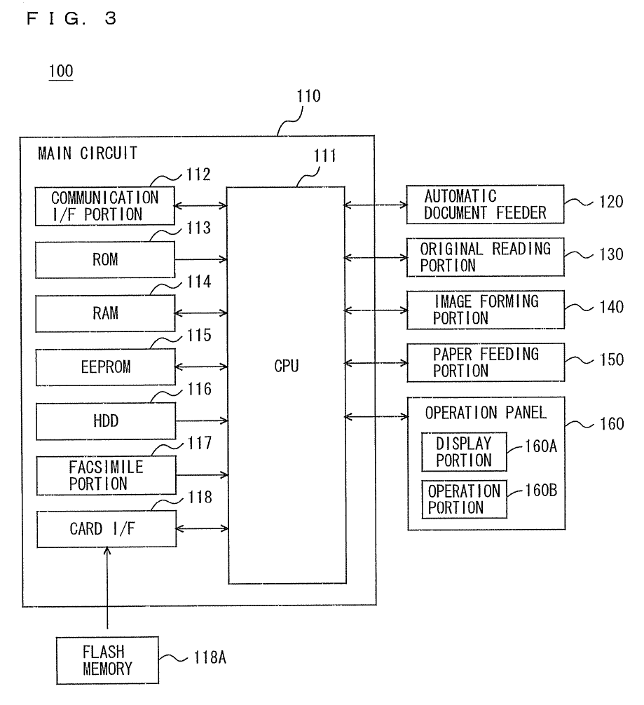

FIG. 2 is a perspective view of the MFP, and FIG. 3 is a block diagram showing an example of the hardware configuration of the MFP. Referring to FIGS. 2 and 3, MFP 100 includes: a main circuit 110; an original reading portion 130 which reads an original; an automatic document feeder 120 which delivers an original to original reading portion 130; an image forming portion 140 which forms, on a sheet of paper or the like, a still image output from original reading portion 130 that read an original; a paper feeding portion 150 which supplies sheets of paper to image forming portion 140; and an operation panel 160 serving as a user interface. Main circuit 110 includes a central processing unit (CPU) 111, a communication interface (I/F) portion 112, a ROM (Read Only Memory) 113, a RAM (Random Access Memory) 114, an EEPROM (Electronically Erasable and Programmable ROM) 115, a hard disk drive (HDD) 116 as a mass storage, a facsimile portion 117, and a card interface (I/F) 118 mounted with a flash memory 118A. CPU 111 is connected with automatic document feeder 120, original reading portion 130, image forming portion 140, paper feeding portion 150, and operation panel 160, and is responsible for overall control of MFP 100.

ROM 113 stores a program executed by CPU 111 or data necessary for execution of the program. RAM 114 is used as a work area when CPU 111 executes a program. Further, RAM 114 temporarily stores still images continuously transmitted from original reading portion 130.

Operation panel 160 is provided on an upper surface of MFP 100, and includes a display portion 160A and an operation portion 160B. Display portion 160A is a display such as a liquid crystal display (LCD) or an organic electro-luminescence display (ELD), and displays an instruction menu for the user, information about acquired image data, and others. Operation portion 160B is provided with a plurality of keys, and accepts input of data such as instructions, characters, and numerical characters, according to the key operations of the user. Operation portion 160B further includes a touch panel provided on display portion 160A.

Communication I/F portion 112 is an interface for connecting MFP 100 to network 2. CPU 111 communicates with PCs 300, 300A to 300F, and projector 200 via communication I/F portion 112, for transmission/reception of data. Further, communication I/F portion 112 is capable of communicating with a computer connected to the Internet via network 2.

Facsimile portion 117 is connected to public switched telephone networks (PSTN), and transmits facsimile data to or receives facsimile data from a facsimile machine connected to the PSTN. Facsimile portion 117 stores the received facsimile data in HDD 116, or outputs it to image forming portion 140. Image forming portion 140 prints the facsimile data received from facsimile portion 117 on a sheet of paper. Further, facsimile portion 117 converts the data stored in HDD 116 to facsimile data, and transmits it to a facsimile machine connected to the PSTN.

Card I/F 118 is mounted with flash memory 118A. CPU 111 is capable of accessing flash memory 118A via card I/F 118. CPU 111 loads a program recorded on flash memory 118A mounted to card I/F 118, to RAM 114 for execution. It is noted that the program executed by CPU 111 is not restricted to the program recorded on flash memory 118A. CPU 111 may load a program stored in HDD 116 to RAM 114 for execution. In this case, another computer connected to network 2 may rewrite the program stored in HDD 116 of MFP 100 or may additionally write a new program. Further, MFP 100 may download a program from another computer connected to network 2, and store the program in HDD 116. As used herein, the “program” includes, not only the program directly executable by CPU 111, but also a source program, a compressed program, an encrypted program, and others.

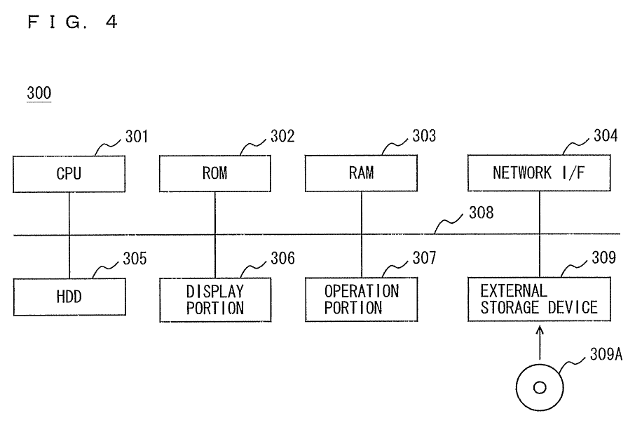

PCs 300 and 300A to 300F are identical in configuration and function, and thus, PC 300 will be described representatively. FIG. 4 is a block diagram showing an example of the hardware configuration of the PC. Referring to FIG. 4, PC 300 includes: a CPU 301 which is responsible for overall control of PC 300; a ROM 302 which stores a program executed by CPU 301 or the like; a RAM 303 used as a work area for CPU 301; a network I/F 304 which connects PC 300 to the network; an HDD 305 as a mass storage; a display portion 306; an operation portion 307 which accepts an input of a user's operation; and an external storage device 309; which are each connected to a bus 308.

External storage device 309 is mounted with a CD-ROM (Compact Disc-ROM) 309A which stores a conference program. CPU 301 loads the conference program stored in CD-ROM 309A via external storage device 309, to RAM 303 for execution. It is noted that the recording medium for storing the conference program is not restricted to CD-ROM 309A. It may be a flexible disk, a cassette tape, an optical disc (MO (Magnetic Optical Disc), MD (Mini Disc), DVD (Digital Versatile Disc)), an IC card, an optical card, or a semiconductor memory such as a mask ROM, an EPROM (Erasable Programmable ROM), an EEPROM (Electronically EPROM), or the like. Alternatively, the program stored in HDD 305 may be loaded to RAM 303 for execution. In this case, PC 300 may download a program from another computer connected to network 2 and store it in HDD 305. As used herein, the “program” includes, not only the one directly executable by CPU 301, but also a source program, a compressed program, an encrypted program, and others.

In the present embodiment, it is assumed that the presenter at a conference stores a document for presentation in the form of still images in PC 300 and causes the presentation document to be displayed on projector 200 via MFP 100, while the participants in the conference operate PCs 300A to 300F to view the presentation document.

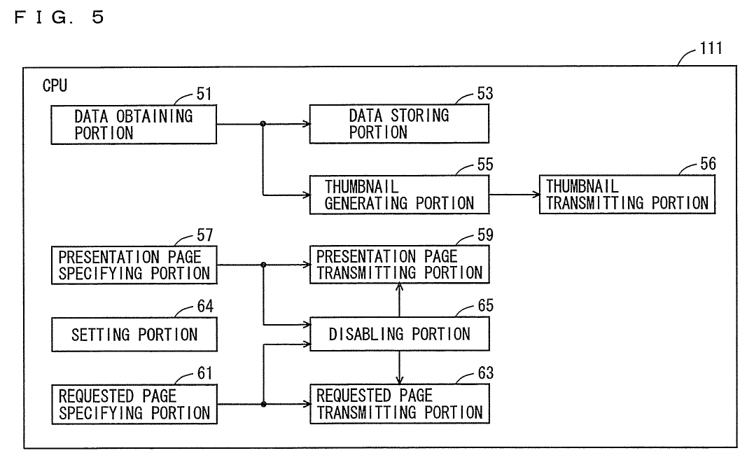

FIG. 5 is a functional block diagram showing an example of the functions of the CPU included in the MFP. Referring to FIG. 5, CPU 111 included in MFP 100 includes: a data obtaining portion 51 for obtaining data; a data storing portion 53 for storing the obtained data; a thumbnail generating portion 55 which generates thumbnails corresponding to images reduced in size; a thumbnail transmitting portion 56 which transmits the thumbnails; a presentation page specifying portion 57 which specifies a page used for presentation (presentation page); a presentation page transmitting portion 59 which transmits the presentation page; a requested page specifying portion 61 which specifies a requested page; a requested page transmitting portion 63 which transmits the requested page; a setting portion 64 which sets a control status for the obtained data; and a disabling portion 65 which disables display or printing of the presentation page or the requested page.

Data obtaining portion 51 obtains data of the presentation document, and outputs the obtained data to data storing portion 53 and thumbnail generating portion 55. More specifically, in the case where the user inputs an instruction to read an image of the original to operation portion 160B, the instruction is input from operation portion 160B to data obtaining portion 51. In receipt of the instruction to read the original, data obtaining portion 51 causes original reading portion 130 to read an image of the original, to thereby obtain the image output from original reading portion 130 that read the image of the original, as data. In the case where original reading portion 130 reads a plurality of originals, data obtaining portion 51 obtains data of a plurality of images collectively.

In the case where communication I/F portion 112 receives print data from PC 300 connected to network 2, data obtaining portion 51 obtains from communication I/F portion 112 the print data that communication I/F portion 112 receives from the PC.

Further, in the case where communication I/F portion 112 receives an image from PC 300 connected to network 2 in accordance with a communication protocol such as FTP (File Transfer Protocol) or SMB (Server Message Block), data obtaining portion 51 obtains the data that communication I/F portion 112 receives from PC 300.

Data storing portion 53 stores the data input from data obtaining portion 51 in HDD 116, in association with the user identification information for identification of the presenter. Here, the user who performed an operation to input the data to MFP 100 is determined as the presenter at the conference, and presentation data having the user identification information of that user associated with the data input from data obtaining portion 51 is generated and stored in HDD 116. In the case where the presenter operates operation portion 160B to input data, the user identification information input by the presenter to operation portion 160B is obtained, while in the case where the data is externally input, the user identification information input together with the data is obtained.

In receipt of the data from data obtaining portion 51, thumbnail generating portion 55 generates a thumbnail corresponding to the image reduced in size of the page data included in the data, and associates the thumbnail with the data stored in HDD 116 by data storing portion 53. In the case where the data includes a plurality of page data, thumbnail generating portion 55 generates a plurality of thumbnails corresponding to the images reduced in size of the plurality of page data, respectively. Here, the data and the thumbnail are associated with each other by the presentation data. The thumbnail is identification information for identification of the page data included in the data. Thumbnail generating portion 55 outputs the generated thumbnails to thumbnail transmitting portion 56.

Setting portion 64 sets the control statuses for the plurality of page data included in the data. Specifically, when the presenter operates PC 300 to transmit a transmission request for a presentation setting screen to MFP 100, setting portion 64 transmits the presentation setting screen to PC 300. The transmission request for the presentation setting screen includes the user identification information of the presenter.

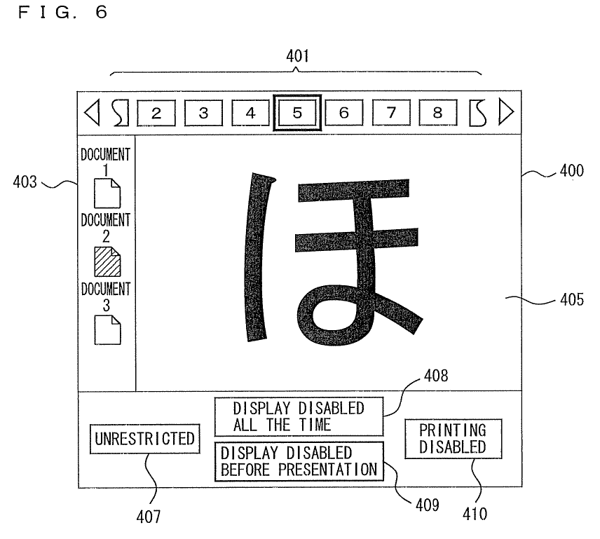

FIG. 6 shows an example of the presentation setting screen. Referring to FIG. 6, the presentation setting screen 400 includes: an area 403 for designating data; an area 401 for displaying thumbnails for a plurality of page data included in the data; an area 405 for displaying the page data to be processed; and buttons 407 to 410 for designating the control statuses.

In area 403, data identification information for the data associated with the user identification information of the presenter are displayed. Here, the file names of the data are used as the data identification information. When any of the file names displayed in area 403 is designated, the designated data is set as a processing target, and PC 300 transmits the data identification information to MFP 100.

In area 401, a plurality of thumbnails corresponding to the images reduced in size of a plurality of page data included in the data which has been set as the processing target in area 403 are displayed. Here, for the sake of explanation, the thumbnails are indicated by the page numbers. When the presenter designates any of the thumbnails, the page data corresponding to the designated thumbnail is set as a processing target, and PC 300 transmits the presentation page information for identification of the page data set as the processing target to MFP 100. In area 405, an image of the page data which has been set as the processing target in area 401 is displayed.

Buttons 407 to 410 are used for setting a control status for the page data which is set as the processing target in area 401. There are four control statuses of “unrestricted”, “display disabled all the time”, “display disabled before presentation”, and “printing disabled”, which are assigned to the respective buttons 407 to 410. The control status “unrestricted” indicates that the page data can be output unconditionally, without any restriction. The control status “display disabled all the time” indicates that the page data can be displayed only on projector 200, with its output to PCs 300 and 300A to 300F being disabled. The control status “display disabled before presentation” indicates that display of the page data is enabled only after it has been displayed on projector 200. The control status “printing disabled” indicates that printing of the page data is disabled. The statuses “display disabled all the time” and “display disabled before presentation” may be set exclusively. It is possible to set “printing disabled” in combination with one of “display disabled all the time” and “display disabled before presentation”. When any of buttons 407 to 410 is designated by the presenter, PC 300 transmits the control status assigned to the designated one of buttons 407 to 410, to MFP 100.

Returning to FIG. 5, when communication I/F portion 112 receives the data identification information, the presentation page information, and the control status from PC 300, setting portion 64 obtains them. Based on the obtained information, setting portion 64 associates the control status with the page data identified by the presentation page information. Here, the page data and the control status are associated with each other by the presentation data.

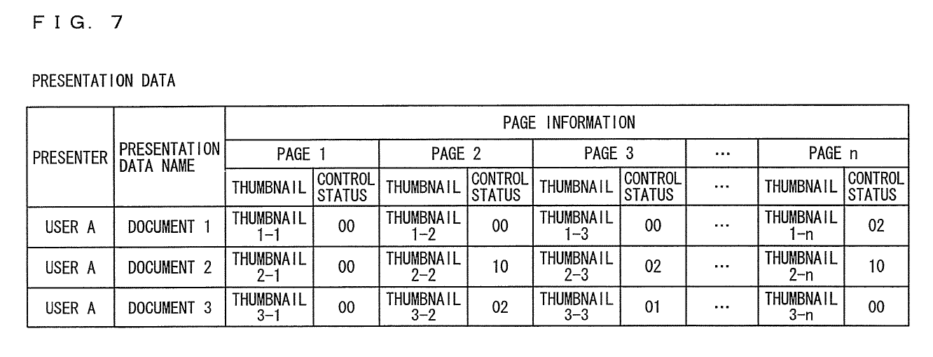

FIG. 7 shows an example of the presentation data. Referring to FIG. 7, the presentation data includes a presentation record for each data. The presentation record includes: a presenter field, a presentation data name field, and a page information field. In the presenter field, the user identification information for identification of the presenter is set. In the presentation data name field, the data identification information for identification of the data is set. The page information field includes a thumbnail field and a control status field for a respective one of the first through n-th pages, where “n” is a positive integer indicating the number of page data included in the data.

In the page information field, thumbnails corresponding to the images of the page data of the first through n-th pages included in the data are set in the corresponding thumbnail fields, and their control statuses are set in the corresponding control status fields. Here, the control status has two digits, with the tens place assigned with printing restriction and the units place assigned with display restriction. In the case of the page for which display and printing are “unrestricted”, “00” is set. In the case of the page with “printing disabled”, “1” is set in the tens place; otherwise, “0” is set therein. In the case of the page with “display disabled all the time”, “1” is set in the units place, while in the case of the page with “display disabled before presentation”, “2” is set in the units place.

Returning to FIG. 5, presentation page specifying portion 57 specifies the page data to be displayed on projector 200 during the presentation by the presenter. More specifically, when the presenter operates PC 300 to transmit a transmission request for a presentation operation screen to MFP 100, presentation page specifying portion 57 transmits the presentation operation screen to PC 300. The transmission request for the presentation operation screen includes the user identification information of the presenter. When the user operates PC 300 to input data identification information and presentation page information, PC 300 transmits the data identification information and the presentation page information to MFP 100, and once communication I/F portion 112 receives those data identification information and presentation page information, presentation page specifying portion 57 obtains them.

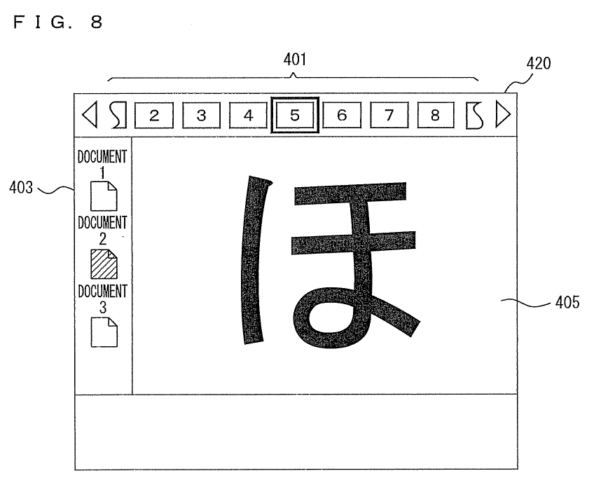

FIG. 8 shows an example of the presentation operation screen. Referring to FIG. 8, the presentation operation screen 420 is identical to the presentation setting screen shown in FIG. 7 except that it does not include buttons 407 to 410. In area 403, the data identification information of the data which are associated with the user identification information of the presenter is displayed. It may be configured to allow the presenter to designate data, in which case the data identification information of the data designated by the presenter may be displayed in area 403. When the user selects one of the data identification information from area 403, a plurality of thumbnails corresponding to a plurality of page data included in the selected data are displayed in area 401. When one of the thumbnails displayed in area 401 is designated, the image of the page data corresponding to the designated thumbnail is displayed in area 405, and the data identification information and the presentation page information for identification of that page data are transmitted to MFP 100.

Returning to FIG. 5, thumbnail transmitting portion 56 transmits thumbnails of the presentation data in response to a request from any of PCs 300A to 300F operated by the participants. More specifically, thumbnail transmitting portion 56 extracts a presentation record including the user identification information of the presenter from the presentation data, and transmits the thumbnails included in the presentation record via communication I/F portion 112 to the one of PCs 300A to 300F that issued the request. In the case where the presentation data includes a plurality of presentation records having the user identification information of the presenter, it transmits the thumbnails included in the respective presentation records.

In the case where the control status has “1” set in its units place, thumbnail transmitting portion 56 transmits a predetermined dummy thumbnail instead of the thumbnail of that page. In the case where the control status has “2” set in its units place, if the page data of that page has been transmitted to projector 200 by presentation page transmitting portion 59, thumbnail transmitting portion 56 transmits the thumbnail of that page; otherwise, it transmits a predetermined dummy thumbnail instead of the thumbnail of that page.

Further, upon transmission of a thumbnail, in the case where “1” is set in the tens place of the control status, thumbnail transmitting portion 56 transmits the thumbnail by changing its display manner to indicate that printing thereof is disabled. That the printing is disabled may be expressed, e.g., by adding a mark indicating that printing is disabled onto the thumbnail, or a thumbnail of a predetermined image may be used for that purpose.

When communication I/F portion 112 receives the data identification information and the presentation page information transmitted from PC 300, presentation page specifying portion 57 obtains them. It then outputs the obtained data identification information and presentation page information to disabling portion 65 and presentation page transmitting portion 59.

When the data identification information and the presentation page information are input from presentation page specifying portion 57, disabling portion 65 refers to the presentation data to extract a presentation record including the data identification information. It then reads, from the extracted presentation record, the control status of the page designated by the presentation page information. If “0” is set in the units place of the control status, disabling portion 65 outputs a transmission enable instruction to presentation page transmitting portion 59, whereas if “1” is set in the units place, it outputs a transmission disable instruction to presentation page transmitting portion 59. Further, if “2” is set in the units place of the control status, disabling portion 65 outputs a transmission enable instruction to presentation page transmitting portion 59 on the condition that the page designated by the presentation page information has been transmitted to projector 200 by presentation page transmitting portion 59, whereas it outputs a transmission disable instruction to presentation page transmitting portion 59 if the page designated by the presentation page information has not been transmitted to projector 200 by presentation page transmitting portion 59.

In receipt of the data identification information and the presentation page information from presentation page specifying portion 57, presentation page transmitting portion 59 reads the data specified by the data identification information from HDD 116, and transmits the page data specified by the presentation page information from among the plurality of page data included in the read data to projector 200. This allows the image of the page data to be thrown onto the screen by projector 200. Further, presentation page transmitting portion 59 transmits the page data specified by the data identification information and the presentation page information to PCs 300A to 300F of the participants, together with the presentation page identification information, on the condition that a transmission enable instruction has been received from disabling portion 65.

Requested page specifying portion 61 specifies page data of a requested page desired by a participant. Specifically, when a participant operates any of PCs 300A to 300F to transmit a transmission request for a viewer screen to MFP 100, requested page specifying portion 61 transmits the viewer screen to the one of PCs 300A to 300F. More specifically, when a participant operates one of PCs 300A to 300F to input data identification information and requested page information, the one of PCs 300A to 300F transmits the data identification information and the requested page information to MFP 100. When communication I/F portion 112 receives the data identification information and the requested page information transmitted from any of PCs 300A to 300F, requested page specifying portion 61 obtains them. It then outputs the obtained data identification information and requested page information to disabling portion 65 and requested page transmitting portion 63.

In receipt of the data identification information and the requested page information from requested page specifying portion 61, disabling portion 65 refers to the presentation data to extract a presentation record including the data identification information. It then reads, from the extracted presentation record, the control status of the page specified by the requested page information. If “0” is set in the units place of the control status, disabling portion 65 outputs a transmission enable instruction to requested page transmitting portion 63, whereas if “1” is set in the units place, it outputs a transmission disable instruction to requested page transmitting portion 63. If “2” is set in the units place of the control status, disabling portion 65 outputs a transmission enable instruction to requested page transmitting portion 63 on the condition that the page specified by the requested page information has already been transmitted to projector 200 by requested page transmitting portion 63, whereas it outputs a transmission disable instruction to requested page transmitting portion 63 if the page specified by the requested page information has not been transmitted to projector 200 by requested page transmitting portion 63.

Further, if “0” is set in the tens place of the control status, disabling portion 65 outputs a printing enable instruction to requested page transmitting portion 63, while if “1” is set in the tens place, it outputs a printing disable instruction to requested page transmitting portion 63.

In receipt of the data identification information and the requested page information, requested page transmitting portion 63 reads the data specified by the data identification information from HDD 116, and transmits the page data specified by the requested page information from among the plurality of page data included in the read data to the one of the participants' PCs 300A to 300F that had transmitted the data identification information and the requested page information, on the condition that a transmission enable instruction has been received from disabling portion 65. In the case where a printing disable instruction has been received from disabling portion 65, requested page transmitting portion 63 transmits the page data for which printing is disabled as well as the data identification information and the requested page information to the one of the participants' PCs 300A to 300F that had transmitted those data identification information and requested page information. This is to prevent the page data for which the presenter disabled printing from being printed by any of the participants' PCs 300A to 300F.

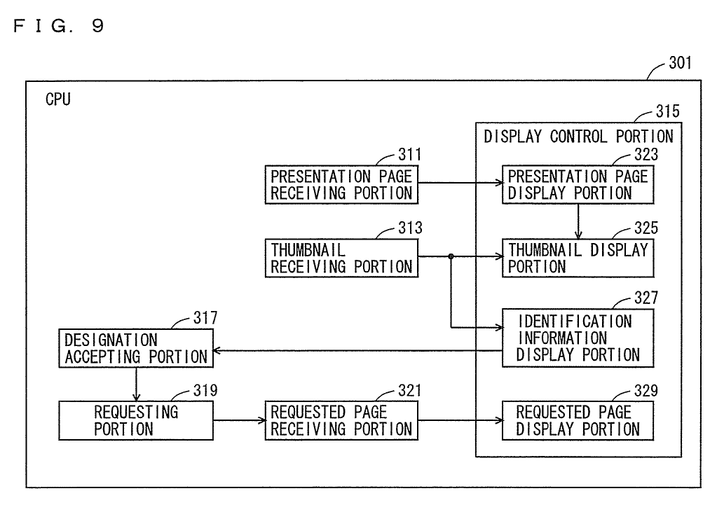

FIG. 9 is a functional block diagram schematically showing the functions of the CPU included in the PC operated by a participant. Here, PC 300A will be described representatively. Referring to FIG. 9, the CPU 301 of PC 300A includes: a presentation page receiving portion 311 which receives a presentation page; a thumbnail receiving portion 313 which receives thumbnails; a display control portion 315 which controls display of a viewer screen; a designation accepting portion 317 which accepts designation of a requested page; a requesting portion 319 which requests transmission of a requested page; and a requested page receiving portion 321 which receives page data of the requested page.

Presentation page receiving portion 311 controls network I/F 304 to receive the page data of the presentation page, the data identification information, and the presentation page information transmitted from MFP 100, and outputs the received page data, data identification information, and presentation page information to display control portion 315. Thumbnail receiving portion 313 controls network I/F 304 to receive the thumbnails transmitted from MFP 100, and outputs the received thumbnails to display control portion 315.

Display control portion 315 includes: a presentation page display portion 323 which displays a presentation page; a thumbnail display portion 325 which displays thumbnails; an identification information display portion 327 which displays identification information; and a requested page display portion 329 which displays a requested page.

Presentation page display portion 323 displays the page data received from presentation page receiving portion 311 in an area for displaying the presentation page on the viewer screen, and further, outputs the data identification information and the presentation page information received from presentation page receiving portion 311 to thumbnail display portion 325.

In receipt of the data identification information and the presentation page information from presentation page display portion 323, thumbnail display portion 325 displays a plurality of thumbnails specified by the data identification information from among the thumbnails input from thumbnail receiving portion 313, in an area for displaying the thumbnails on the viewer screen. Thumbnail display portion 325 displays the thumbnail of the presentation page specified by the presentation page information input from presentation page display portion 323 and the thumbnails of the pages preceding and succeeding the presentation page in a row, with the thumbnail of the presentation page arranged at the center and displayed in a manner different from the display manner of the other thumbnails. For example, the thumbnail of the presentation page specified by the presentation page information is displayed brighter than the thumbnails of the other pages.

In this manner, the thumbnails corresponding to part of the plurality of page data included in the data are displayed, with the thumbnails of the pages preceding and succeeding the presentation page being centered around the thumbnail of the presentation page. This allows the participant to confirm the pages preceding and succeeding the presentation page with the thumbnails. Further, the thumbnail of the presentation page displayed brighter than the other thumbnails can notify the participant of the thumbnail of the presentation page among the plurality of thumbnails. As to the page data for which display is disabled by the presenter, a dummy thumbnail is displayed, which suppresses display of the thumbnail of the page data for which display is disabled by the presenter. Further, the thumbnail of the page data for which printing is disabled by the presenter is displayed in such a manner to indicate that printing thereof is disabled, which allows the participant to know from the thumbnail that it is not possible to print the page data.

Identification information display portion 327 displays, from among the thumbnails input from thumbnail receiving portion 313, a plurality of thumbnails specified by the data identification information that the participant designated on the viewer screen, in an area for displaying the identification information on the viewer screen.

Designation accepting portion 317 accepts designation of one of the thumbnails displayed in the area for displaying the identification information on the viewer screen. Designation accepting portion 317 outputs the data identification information of the data including the page data corresponding to the designated thumbnail, and the requested page information for identification of the page data corresponding to that thumbnail, to requesting portion 319.

Requesting portion 319 transmits a transmission request including the data identification information and the requested page information input from designation accepting portion 317, to MFP 100. As described above, in receipt of the transmission request, MFP 100 transmits the page data specified by the data identification information and the requested page information. Thus, requested page receiving portion 321 controls network I/F 304 to receive the page data transmitted from MFP 100, and outputs the received page data to display control portion 315.

In receipt of the page data from requested page receiving portion 321, requested page display portion 329 displays the page data in an area for displaying a requested page on the viewer screen. This allows the participant to view the image of the desired page of the desired data, irrespective of the image of the page designated by the presenter for presentation.

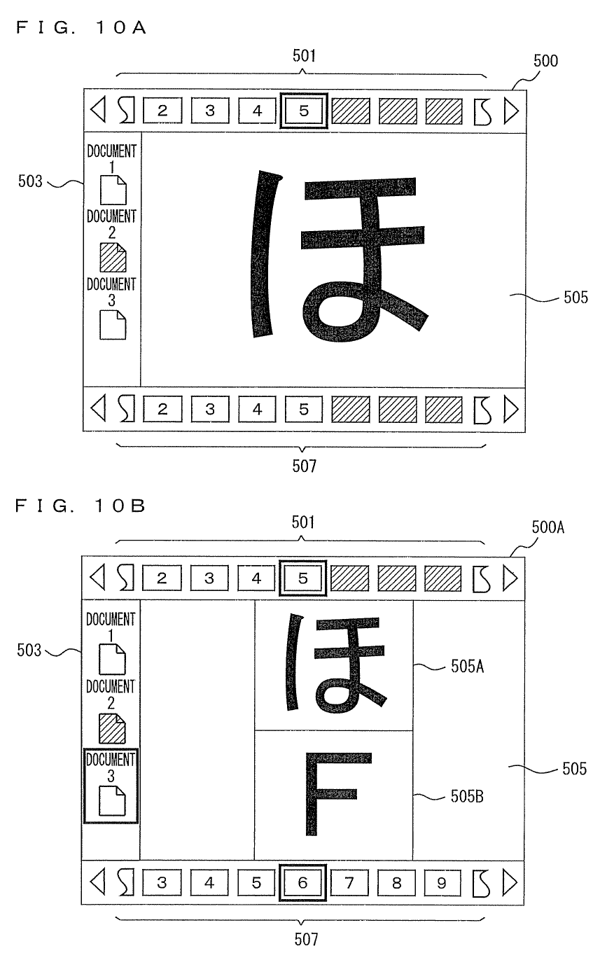

FIG. 10A shows an example of the viewer screen. Referring to FIG. 10A, the viewer screen 500 includes: a data area 503 for use in designating data; a presentation page mark area 501 for displaying thumbnails of a plurality of page data including the page data of a presentation page; a page display area 505 for displaying the page data as a processing target; and a requested page mark area 507 for displaying identification information.

In data area 503, data identification information of the data associated with the user identification information of the presenter is displayed. Here, the file name of each data is employed as the data identification information. Hatching applied to the data with the file name “document 2” indicates that the data has been selected by the presenter. When any of the file names displayed in data area 503 is designated, the data identification information of the designated data is transmitted to MFP 100.

In presentation page mark area 501, thumbnails corresponding to the images reduced in size of a plurality of page data included in the presentation data designated by the presenter are displayed. Here, the page numbers are applied to the thumbnails for the sake of explanation. The thumbnail corresponding to page 5 is displayed in a manner different from the display manner of the other thumbnails, indicating that the page data of page 5 in the data with the file name “document 2” is currently used by the presenter for presentation.

In the figure, the bold line delimiting the thumbnail indicates that the thumbnail is displayed in a different manner, e.g., increased in brightness than the other thumbnails. Further, the thumbnail corresponding to page 5, which is currently used for presentation, is arranged at the center, with the thumbnails of the preceding and succeeding pages displayed to the left and right, respectively, of the thumbnail of page 5.

Here, it is assumed that display of the page data before presentation is disabled, with “2” being set in the units place of the control status. Thus, dummy thumbnails are displayed in place of the thumbnails for the plurality of page data before presentation. Here, the dummy thumbnails are shown with hatching.

In page display area 505, the image of the page data of page 5, which is currently used for presentation, is displayed.

In requested page mark area 507, thumbnails corresponding respectively to a plurality of page data included in the data which is specified by the data identification information designated by the participant from among the data identification information displayed in data area 503, are displayed as the identification information. Shown here is the case where the thumbnails the same as those displayed in presentation page mark area 501 are displayed in requested page mark area 507.

When the user designates one of the thumbnails displayed in area 507, PC 300A transmits to MFP 100 the data identification information of the data including the page data corresponding to the designated thumbnail, and the requested page information for identification of that page data. Once MFP 100 returns the page data specified by the data identification information and the requested page information, PC 300A displays the page data received from MFP 100 in page display area 505 as a processing target.

FIG. 10B shows another example of the viewer screen. The viewer screen 500A shown in FIG. 10B is the screen which is displayed when the file name “document 3” is designated in data area 503 and page 6 is designated in requested page mark area 507 in viewer screen 500 shown in FIG. 10A.

Referring to FIG. 10B, the file name “document 3” in data area 503 is delimited by the bold line, indicating that the data with the file name “document 3” has been designated.

Presentation page mark area 501 is identical to presentation page mark area 501 on viewer screen 500 shown in FIG. 10A. In requested page mark area 507, thumbnails corresponding to a plurality of page data included in the data having the file name “document 3” are displayed. Here, the thumbnail of page 6 is delimited by the bold line, indicating that the thumbnail of page 6 has been designated by the user. Further, the thumbnail of page 6 in “document 3”, which is the designated page, is arranged at the center, with the thumbnails of the preceding and succeeding pages being displayed to the left and right, respectively, of the thumbnail of page 6.

In page display area 505, the image of the page data of page 5 in the data with the file name “document 2”, which is currently used for presentation, is displayed in an area 505A, while the image of the page data of page 6 in the data with the file name “document 3”, which has been designated by the user, is displayed in an area 505B. Areas 505A and 505B are identical in size, with the images displayed therein being identical in size as well. This allows the user to confirm the image of the page data currently used for presentation and the image of the page data designated by the user at the same time. It is noted that when the presenter changes the page used for presentation, the image of the page data corresponding to the page after change is displayed in area 505A, with the thumbnail corresponding to the page after change being arranged at the center in presentation page mark area 501, with its display manner differentiated from that of the other thumbnails.

While it has been configured such that the image of the page data of page 5 in “document 2”, currently used for presentation, and the image of the page data of page 6 in “document 3”, designated by the user as the participant, are displayed in the same size in the example above, alternatively, it may be configured such that the image of the page data of page 6 in “document 3” is displayed over the entire area of page display area 505, with the image of the page data of page 5 in “document 2” corresponding to the page currently used for presentation being not displayed in page display area 505. Still in this case, the thumbnail corresponding to the page data of page 5 in “document 2” is displayed in presentation page mark area 501, allowing the user to confirm the content of the page data of the presentation page by checking the thumbnail. When the presenter changes the page used for presentation, presentation page mark area 501 is updated so that the thumbnail corresponding to the page data of the page after change is arranged at the center of presentation page mark area 501 and displayed in a manner different from that of the other thumbnails.

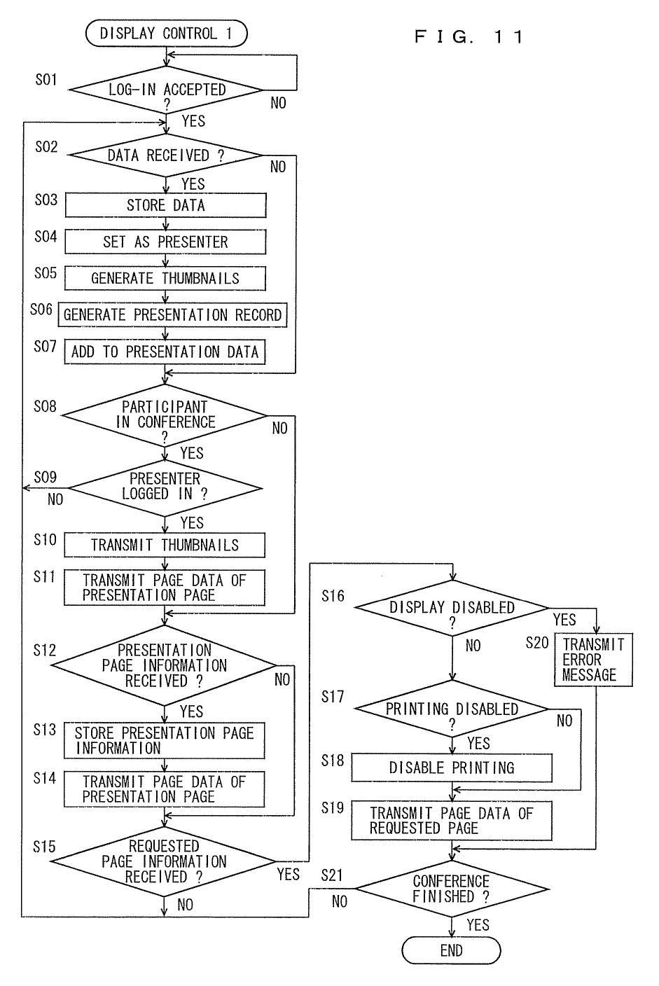

FIG. 11 is a flowchart illustrating an example of the flow of display control processing carried out in the MFP. The display control processing is carried out by CPU 111 included in MFP 100 as CPU 111 executes a display control program. Referring to FIG. 11, CPU 111 determines whether log-in of a user has been accepted (step S01). CPU 111 is in a standby mode until user log-in is accepted (NO in step S01), and once the log-in is accepted (YES in step S01), the process proceeds to step S02. Specifically, a log-in request is accepted from one of PCs 300 and 300A to 300F, and when authentication is successful, the process proceeds to step S02. CPU 111 performs the display control processing on the condition that log-in is accepted. This means that it generates task processes of the number corresponding to the number of accepted log-in, and performs them in parallel. Hereinafter, the user whose log-in has been accepted and authenticated is referred to as the “logged-in user”.

In step S02, it is determined whether data has been received. If so, the process proceeds to step S03; otherwise, the process proceeds to step S08. In the case where the process proceeds to step S03, the received data is stored in HDD 116 (step S03), and the logged-in user is set as the presenter at the conference (step S04). In the case where a plurality of data are received, the respective data are stored in HDD 116. Thumbnails are generated for respective images of a plurality of page data included in the data (step S05). In the case where a plurality of data are received, the thumbnails are generated for each of the data. A presentation record is generated (step S06), and added to the presentation data stored in HDD 116 for storage (step S07). In the case where a plurality of data are received, the presentation records are generated for the respective data, and added to the presentation data for storage.

In step S08, it is determined whether the logged-in user is a participant in the conference. With the participants in the conference being registered in advance in MFP 100, it is determined whether the logged-in user has been registered as the participant. If the user has been registered as the participant, the process proceeds to step S09; otherwise, the process proceeds to step S12. Here, it is assumed that the participant operating PC 300A has logged in.

In step S09, it is determined whether the presenter has logged in. Specifically, it is determined whether there is another task process which has been started in response to log-in of a presenter and, hence, step S04 has been executed in that task process to set the user as the presenter. If the presenter has logged in, the process proceeds to step S10; otherwise, the process returns to step S02.

In step S10, thumbnails are transmitted to PC 300A which is operated by the participant who logged in in step S09. Specifically, the thumbnails generated in step S05 are transmitted to PC 300A via communication I/F portion 112. In the case where a plurality of data are received in step S02, the thumbnails generated corresponding to the respective data are transmitted. In the following step S11, the page data of the presentation page is transmitted to PC 300A of the logged-in user. Specifically, the page data of the presentation page which is specified by the presentation page information received in step S12, which will be described later, is transmitted to PC 300A via communication I/F portion 112. In the case where “1” is set in the units place in the control status of the presentation page, however, the page data is not transmitted, because the presenter restricts such that the page data of that page is displayed only on projector 200.

In step S12, it is determined whether presentation page information has been received from PC 300 operated by the presenter. If the presentation page information is received, the process proceeds to step S13; otherwise, the process proceeds to step S15. In the case where a plurality of data are received in step S02, data identification information is received in addition to the presentation page information.

In step S13, the received presentation page information is stored in HDD 116. Then, the page data specified by the presentation page information is extracted from the presentation data stored in HDD 116. The extracted page data is transmitted to projector 200 as well as to every one of PCs 300A to 300F operated by the users who logged in as the participants (step S14). In the case where “1” is set in the units place in the control status of the presentation page, however, the page data is not transmitted to any of PCs 300A to 300F operated by the user who logged in as the participant, because the presenter restricts such that it is displayed only on projector 200. Step 14 differs from step S11 in that, while the page data specified by the presentation page information is transmitted to PC 300A operated by the logged-in participant in step S11, in step S14, the page data is transmitted to every one of PCs 300A to 300F operated by the participants who have logged in at that time.

In the following step S15, it is determined whether requested page information has been received from one of PCs 300A to 300F operated by the participants. If communication I/F portion 112 receives the requested page information from one of PCs 300A to 300F, the process proceeds to step S16; otherwise, the process returns to step S02. In the case where a plurality of data are received in step S02, data identification information is received in addition to the requested page information.

In step S16, it is determined whether display of the page data specified by the requested page information has been disabled. Specifically, the presentation data stored in HDD 116 is searched, and if “1” is set in the units place of the control status of the page specified by the requested page information, or if “2” is set in the units place and the page data is not transmitted in step S14, it is determined that the display is disabled. If it is determined that the display is disabled, the process proceeds to step S20; otherwise, the process proceeds to step S17.

In step S17, it is determined whether printing of the page data specified by the requested page information has been disabled. Specifically, as a result of search of the presentation data stored in HDD 116, if “1” is set in the tens place of the control status of the page specified by the requested page information, it is determined that printing is disabled. If it is determined that printing is disabled, the process proceeds to step S18; otherwise, the process proceeds to step S19, with step S18 being skipped. In step S18, printing of the page data specified by the requested page information is disabled. For example, a command to disable printing is embedded in the page data.

In step S19, the page data specified by the requested page information is transmitted to the one of PCs 300A to 300F which had transmitted the requested page information. Specifically, the page data specified by the requested page information is transmitted via communication I/F portion 112. Here, because PC 300A had transmitted the requested page information, the page data specified by the requested page information is displayed in PC 300A.

In step S21, it is determined whether the conference has finished. If so, the process is terminated; otherwise, the process returns to step S02. In the case where a termination command is received from PC 300 operated by the presenter, or in the case where the communication session with PC 300A is disconnected, it is determined that the conference has finished. PC 300 may output the termination command when a conference termination button provided in advance is designated.

In step S20, an error message is transmitted to the one of PCs 300A to 300F that had transmitted the requested page information. Specifically, the page data specified by the requested page information is transmitted via communication I/F portion 112.

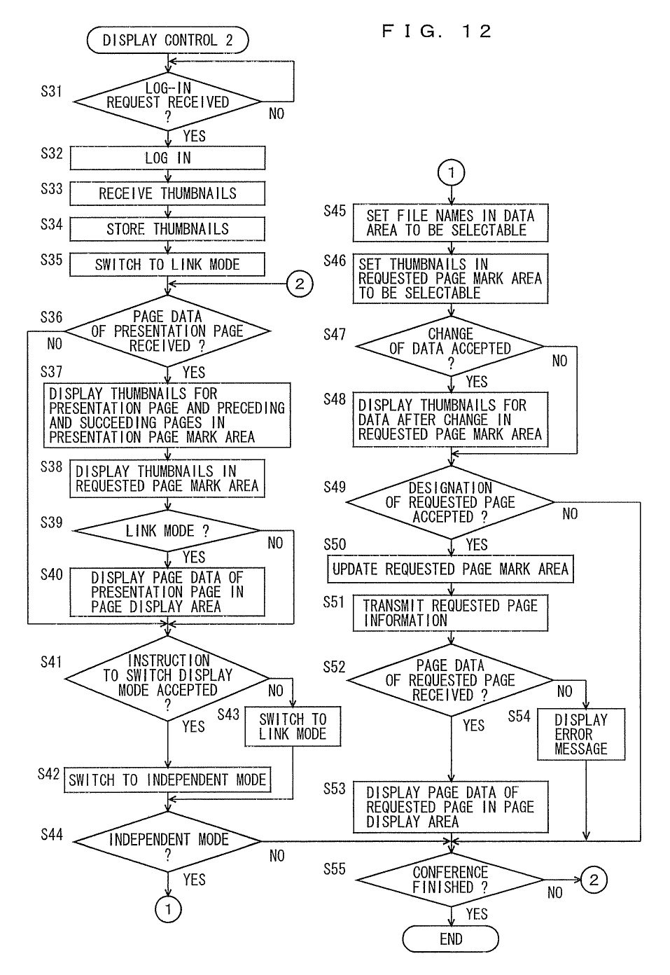

FIG. 12 is a flowchart illustrating an example of the flow of display control processing carried out in the PC. This display control processing is carried out by CPU 301 included in each of PCs 300A to 300F operated by the participants as CPU 301 executes a display control program. Here, it is assumed that PC 300A executes the display control program.

Referring to FIG. 12, CPU 301A determines whether a log-in request has been accepted (step S31). CPU 301A is in a standby mode until a log-in request is accepted (NO in step S31), and once the log-in request is accepted, the process proceeds to step S32. As used herein, the “log-in request” refers to the request for logging in to MFP 100.

In step S32, the log-in request including the user identification information for identification of the user who is operating PC 300A is transmitted to MFP 100 for log in. When a participant logs in, MFP 100 transmits thumbnails corresponding to the images reduced in size of a plurality of page data included in the data received from PC 300 operated by the presenter who has already logged in, and thus, PC 300A receives the thumbnails from MFP 100 (step S33). In the case where MFP 100 receives a plurality of data from PC 300 operated by the presenter who has already logged in, MFP 100 transmits thumbnails for the plurality of data, and thus, PC 300A receives those thumbnails from MFP 100.

The received thumbnails are stored in HDD 305 (step S34). Then, the display mode is switched to a link mode (step S35). Next, it is determined whether the page data of the presentation page has been received from MFP 100 (step S36). When the presentation page information is received from PC 300 operated by the presenter, MFP 100 transmits the page data specified by the presentation page information to PCs 300A to 300F operated by the participants. At the time point when the user of PC 300A logs in, MFP 100 transmits to PC 300A the page data of the presentation page already transmitted to other PCs. Thus, it is determined whether the page data transmitted from MFP 100 has been received via network I/F 304. If the page data of the presentation page is received, the process proceeds to step S37; otherwise, the process proceeds to step S41. In the case where the thumbnails corresponding to a plurality of data are received from MFP 100 in step S33, the data identification information is transmitted from MFP 100 together with the page data of the presentation page, and thus, the data identification information is received as well.

In step S37, the thumbnails of the presentation page and the preceding and succeeding pages are displayed in presentation page mark area 501 which is the area for displaying thumbnails on viewer screen 500 shown in FIG. 10A. In the following step S38, some of the thumbnails stored in HDD 305 in step S34 are displayed in requested page mark area 507 which is the area for displaying identification information on viewer screen 500 shown in FIG. 10A. The thumbnails firstly displayed in presentation page mark area 501 may be the same as those displayed in requested page mark area 507. Even in this case, the thumbnails displayed in requested page mark area 507 may be changed to different thumbnails, independent of those displayed in presentation page mark area 501.

In step S39, it is determined whether the display mode has been switched to the link mode. The display mode is switched to the link mode in step S35, and afterwards, it is switched to either the independent mode or the link mode in either step S42 or S43, as will be described later. If the display mode has been switched to the link mode, the process proceeds to step S40. In contrast, if the display mode has been switched to the independent mode, the step proceeds to step S41, with step S40 being skipped.

In step S40, the page data received in step S36 is displayed in page display area 505 on viewer screen 500. As a result, the page data of the presentation page designated by the presenter operating PC 300 is displayed in page display area 505. The page data of the presentation page corresponds to the page data which is being displayed on projector 200.

In step S41, it is determined whether an instruction to switch the display mode has been accepted. When the user as the participant operates operation portion 307 to input the instruction to switch the display mode, the display mode switching instruction is accepted. If the instruction to switch to the independent mode is accepted, the process proceeds to step S42, while if the instruction to switch to the link mode is accepted, the process proceeds to step S43. In step S42, the display mode is switched to the independent mode, and the process proceeds to step S44. In step S43, the display mode is switched to the link mode, and then, the process proceeds to step S44.

In step S44, it is determined whether the display mode has been switched to the independent mode. If so, the process proceeds to step S45; otherwise, the process proceeds to step S55.

In step S45, the file names displayed in data area 503 on viewer screen 500 are set to be selectable. This allows the user as the participant to select any one of the file names displayed in data area 503 by operating operation portion 307 in PC 300A.

In the following step S46, the thumbnails displayed in requested page mark area 507 on viewer screen 500 are set to be selectable. This allows the user as the participant to select any one of the thumbnails (identification information) displayed in requested page mark area 507 by operating operation portion 307 in PC 300A.

In step S47, it is determined whether a change of data has been accepted. When the file name displayed in data area 503 on viewer screen 500 is selected, the change of data is accepted. If the change of data is accepted, the process proceeds to step S48; otherwise, the process proceeds to step S49, with step S48 being skipped. In step S48, the thumbnails corresponding to the data after change are read from HDD 305, and some of them are displayed in requested page mark area 507 on viewer screen 500. The thumbnails are set to be selectable in step S46, so that the thumbnails corresponding to the data after change are selectable.

In step S49, it is determined whether a designation of a requested page has been accepted. When the user inputs in operation portion 307 the designation to select an arbitrary one of the thumbnails displayed in requested page mark area 507 on viewer screen 500, the designation of the requested page is accepted. The requested page is the page data corresponding to the selected thumbnail (identification information). If the designation of the requested page is accepted, the process proceeds to step S50; otherwise, the process proceeds to step S55.

In step S50, requested page mark area 507 on viewer screen 500 is updated. Specifically, of the thumbnails displayed in requested page mark area 507, the display manner of the thumbnail selected by the user is differentiated from the display manner of the other thumbnails. For example, the selected thumbnail is displayed brighter than the other thumbnails. Alternatively, the selected thumbnail may be marked with a bold frame, to indicate that it has been selected. This allows the user to confirm the selected page data.

In step S51, the requested page information for identification of the page data corresponding to the thumbnail selected by the user is transmitted to MFP 100. Specifically, the requested page information is transmitted to MFP 100 via network I/F 304. In the case where the data is changed in step S47, the data identification information of the data after change is transmitted in addition to the requested page information. In receipt of the requested page information, MFP 100 returns the page data if display of the page data specified by the requested page information is enabled; otherwise, it outputs an error message indicating that the display is disabled. Thus, in step S52, it is determined whether the page data of the requested page has been received. If the page data of the requested page is received, the process proceeds to step S53; otherwise, the process proceeds to step S54. In step S54, the error message received from MFP 100 is displayed on display portion 306.

In step S53, the received page data of the requested page is displayed in page display area 505 on viewer screen 500A shown in FIG. 10B. As a result, the image of the page data of the page currently used for presentation by the presenter is displayed in area 505A, and the image of the page data that the user as the participant designated in PC 300A is displayed in area 505B on viewer screen 500A in FIG. 10B. Because the image of the page data currently used for presentation by the presenter and the image of the page data the user as the participant designated in PC 300A are displayed in the same size, the participant is able to check the content being presented while viewing the related image, with a single viewer screen 500A.

In step S55, it is determined whether the conference has finished. If so, the process is terminated; otherwise, the process returns to step S36.

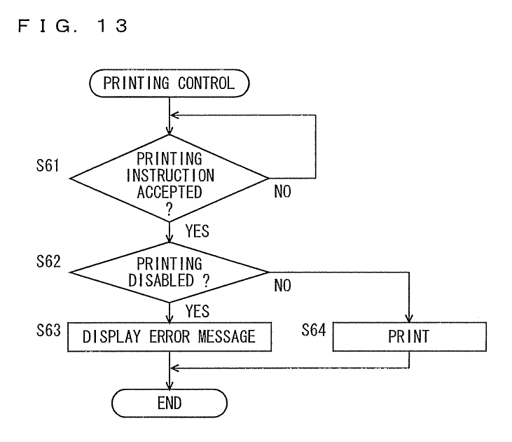

FIG. 13 is a flowchart illustrating an example of the flow of printing control processing carried out in the PC. The printing control processing is carried out by CPU 301 included in each of PCs 300A to 300F operated by the participants as CPU 301 executes a printing control program. Here, it is assumed that PC 300A executes the printing control program. As described above, the page data received from MFP 100 is set as “printing disabled” in the case where the presenter disables printing thereof.

Referring to FIG. 13, CPU 301A is in a standby mode until a printing instruction is accepted (NO in step S61), and once the printing instruction is accepted (YES in step S61), the process proceeds to step S62. When the user inputs a printing instruction to operation portion 307, the printing instruction is accepted.

In step S62, it is determined whether printing of the page data of which printing was instructed has been disabled. If the printing is disabled, the process proceeds to step S63; otherwise, the process proceeds to step S64.

In step S63, an error message is displayed on display portion 306, and the process is terminated. Here, the error message indicates that the printing is disabled. In step S64, the page data is printed, and the process is terminated. The participants are not allowed to print the page data of which printing is disabled by the presenter, in deference to the presenter's will.

### <Modification>

In conference system 1 described above, the thumbnails and the page data are transmitted from MFP 100 to PCs 300A to 300F of the participants. Alternatively, a screen for display on the participants' PCs 300A to 300F may be generated in MFP 100 and transmitted to the participants' PCs 300A to 300F. In this case, MFP 100 functions as a Web server, and in response to a request from PCs 300A to 300F of the participants, it generates and returns a Web page described in a markup language such as HTML (Hypertext Markup Language). This only requires installation of a browsing program to the participants' PCs 300A to 300F to allow the viewer screen to be displayed on display portion 306.

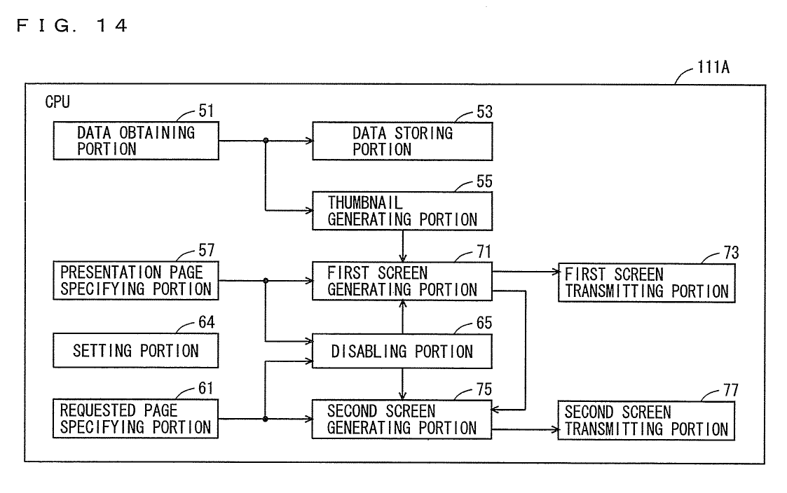

Hereinafter, the conference system according to the modification will be described, primarily focusing on the differences from the above-described conference system. FIG. 14 is a functional block diagram schematically showing the functions of the CPU included in the MFP according to the modification. The block diagram in FIG. 14 differs from that in FIG. 5 in that thumbnail transmitting portion 56 is not provided, that presentation page transmitting portion 59 is replaced with a first screen generating portion 71 and a first screen transmitting portion 73, and that requested page transmitting portion 63 is replaced with a second screen generating portion 75 and a second screen transmitting portion 77.

First screen generating portion 71 receives thumbnails from thumbnail generating portion 55, and receives data identification information and presentation page information from presentation page specifying portion 57. In receipt of the data identification information and the presentation page information from presentation page specifying portion 57, first screen generating portion 71 reads the data specified by the data identification information from HDD 116, extracts the page data specified by the presentation page information from the plurality of page data included in the read data, and transmits the extracted page data to projector 200. This allows the image of the page data to be displayed by projector 200.

Further, first screen generating portion 71 generates viewer screen 500 with the thumbnails input from thumbnail generating portion 55 and the page data specified by the presentation page information. Specifically, of the thumbnails input from thumbnail generating portion 55, the thumbnails corresponding to the page data specified by the presentation page information and the preceding and succeeding pages of that page are arranged in presentation page mark area 501 on viewer screen 500, and the same thumbnails are arranged in requested page mark area 507 as well. Furthermore, the image of the page data specified by the presentation page information is arranged in page display area 505. The data identification information for identification of the data which are associated with the user identification information of the presenter by the presentation data, the file names in this example, are arranged in data area 503 on viewer screen 500. On the condition that a transmission enable instruction is input from disabling portion 65, first screen generating portion 71 outputs the generated viewer screen to first screen transmitting portion 73 and second screen generating portion 75.

In receipt of viewer screen 500 from first screen generating portion 71, first screen transmitting portion 73 transmits the screen to the participants' PCs 300A to 300F.

In receipt of the data identification information and the requested page information from requested page specifying portion 61, second screen generating portion 75 reads the data specified by the data identification information from HDD 116, and extracts the page data specified by the requested page information from among the plurality of page data included in the read data. Second screen generating portion 75 generates viewer screen 500A, as shown in FIG. 10B, from viewer screen 500, as shown in FIG. 10A, which is input from first screen generating portion 71. Specifically, the image of the page data displayed in page display area 505 on viewer screen 500 is arranged in area 505A in page display area 505 on viewer screen 500A, and the image of the extracted page data is arranged in area 505B in page display area 505. Further, in the case where a printing disable instruction is input from disabling portion 65, second screen generating portion 75 arranges the image of the page data for which printing is disabled in area 505B in page display area 505. This is to prevent the image of the page data of which printing is disabled by the presenter from being printed by PCs 300A to 300F of the participants. Second screen generating portion 75 then outputs the generated viewer screen 500A to second screen transmitting portion 77 on the condition that a transmission enable instruction is input from disabling portion 65.

Second screen transmitting portion 77 transmits viewer screen 500A input from second screen generating portion 75 to the one of PCs 300A to 300F of the participants that had transmitted the data identification information and the requested page information, on the condition that the transmission enable instruction is input from disabling portion 65.

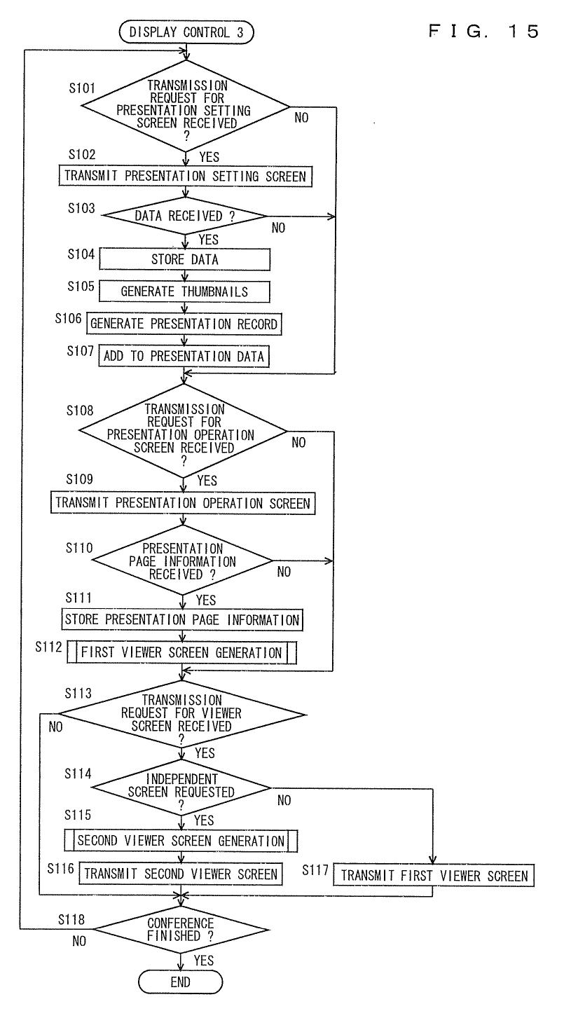

FIG. 15 is a flowchart illustrating an example of the flow of display control processing carried out by the CPU included in the MFP according to the modification. Referring to FIG. 15, CPU 111A determines whether a transmission request for a presentation setting screen has been received (step S101). If the transmission request for the presentation setting screen is received, the process proceeds to step S102; otherwise, the process proceeds to step S108. Here, it is assumed that the transmission request for the presentation setting screen is received from PC 300 operated by the presenter.

In step S102, the presentation setting screen is transmitted to PC 300 that issued the transmission request. It is then determined whether data has been received from PC 300 to which the presentation setting screen was transmitted (step S103). If the data is received, the process proceeds to step S104; otherwise, the process proceeds to step S108. In step S104, the received data is stored in HDD 116. In the case where a plurality of data are received, they are stored in HDD 116.

In the following step S105, thumbnails corresponding to the images reduced in size of the plurality of page data included in the received data are generated. In the case where a plurality of data are received, the thumbnails are generated for the respective data. A presentation record is then generated (step S106), and the generated presentation record is added to the presentation data stored in HDD 106 for storage (step S107). In the case where a plurality of data are received, the presentation records are generated for the respective data, and added to the presentation data for storage.

In step S108, it is determined whether a transmission request for a presentation operation screen has been received. If the transmission request for the presentation operation screen is received from PC 300 to which the presentation setting screen was transmitted in step S102, the process proceeds to step S109; otherwise, the process proceeds to step S113. In step S109, the presentation operation screen is transmitted to PC 300 that issued the transmission request for the presentation operation screen.

In step S110, it is determined whether presentation page information has been received. If so, the process proceeds to step S111; otherwise, the process proceeds to step S113. In the case where a plurality of data are received in step S103, data identification information is received in addition to the presentation page information. In step S111, the received presentation page information is stored in HDD 116. In the following step S112, first viewer screen generating processing is carried out, which will be described later.

In step S113, it is determined whether a transmission request for a viewer screen has been received. If so, the process proceeds to step S114; otherwise, the process proceeds to step S118. Here, it is assumed that the transmission request for the viewer screen is received from PC 300A operated by a participant.

In step S114, it is determined whether the transmission request for the viewer screen requests an independent screen. If so, the process proceeds to step S115; otherwise, the process proceeds to step S117.

In step S115, second viewer screen generating processing is carried out, and the process proceeds to step S116. The second viewer screen generating processing will be described later. In step S116, the generated second viewer screen is transmitted to PC 300A that issued the viewer screen transmission request, and the process proceeds to step S118.

In step S117, the first viewer screen generated in step S112 is transmitted to PC 300A that issued the viewer screen transmission request, and the process proceeds to step S118.

In step S118, it is determined whether the conference has finished. If so, the process is terminated; otherwise, the process returns to step S101.

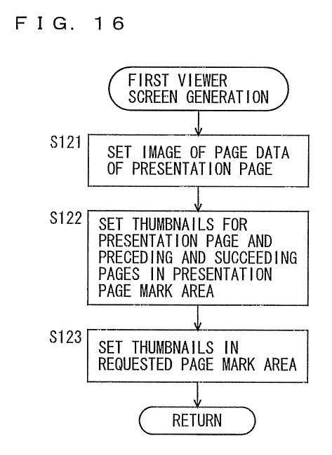

FIG. 16 is a flowchart illustrating an example of the flow of the first viewer screen generating processing, which is performed in step S112 in FIG. 15. Referring to FIG. 16, in step S121, the image of the page data of the presentation page is set in page display area 505 on viewer screen 500.

Then, the thumbnails corresponding to the page data of the presentation page and the preceding and succeeding pages are displayed in presentation page mark area 501 on viewer screen 500 (step S122). At this time, the thumbnail corresponding to the presentation page is arranged at the center, while the thumbnails corresponding to the preceding and succeeding pages are arranged on both sides thereof. Further, the thumbnail for the presentation page is displayed in a manner different from that of the other thumbnails. This can notify the user of the position where the page data of the presentation page is arranged among the plurality of page data included in the data.

In step S123, some of the thumbnails corresponding to the respective page data included in the data are arranged in requested page mark area 507 on viewer screen 500, and the process returns to the display control processing.

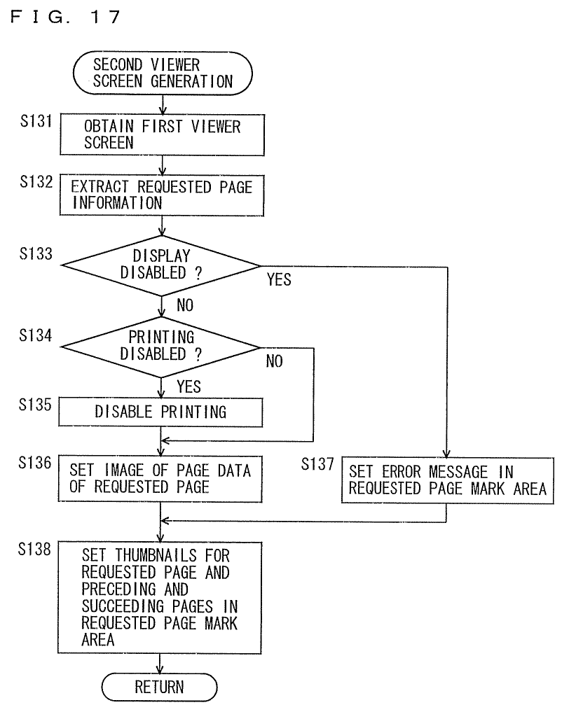

FIG. 17 is a flowchart illustrating an example of the flow of the second viewer screen generating processing, which is performed in step S115 in the display control processing shown in FIG. 15. The second viewer screen generating processing is the processing of generating a second viewer screen from a first viewer screen. Here, it is assumed that viewer screen 500 shown in FIG. 10A corresponds to the first viewer screen, and viewer screen 500A shown in FIG. 10B corresponds to the second viewer screen generated from the first viewer screen.

Referring to FIG. 17, in step S131, the first viewer screen is obtained. Specifically, the first viewer screen generated in step S112 in FIG. 15 is obtained. Then, the requested page information is extracted from the transmission request for the viewer screen received in step S113 in FIG. 15 (step S132). Next, the presentation data stored in HDD 116 is searched to determine whether the control status of the page data specified by the extracted requested page information is set as “display disabled” (step S133). If so, the process proceeds to step S137; otherwise, the process proceeds to step S134.

In step S134, it is determined whether the control status of the page data specified by the extracted requested page information is set as “printing disabled”. If so, the process proceeds to step S135; otherwise, the process proceeds to step S136, with step S135 being skipped. In step S135, printing of the image of the page data specified by the extracted requested page information is disabled. Specifically, a command to disable printing is embedded in the header of the image.

In step S136, the image of the page data of the requested page is arranged in area 505B in page display area 505 on viewer screen 500A, and the process proceeds to step S138. The image arranged in page display area 505 on viewer screen 500 is arranged in area 505A in page display area 505 on viewer screen 500A.

In step S137, an error message is set in requested page mark area 507 on viewer screen 500A. The error message indicates that the image of the page data of the requested page cannot be displayed.

In step S138, the thumbnails for the requested page and the preceding and succeeding pages are set in requested page mark area 507 on viewer screen 500A, and the process returns to the display control processing shown in FIG. 15.

As described above, according to conference system 1 of the present embodiment including MFP 100 serving as the data processing apparatus, PC 300 serving as the apparatus for presentation operated by the presenter at the conference, and PCs 300A to 300F operated by the participants in the conference, when MFP 100 receives presentation page information from PC 300 operated by the presenter, it transmits presentation page data specified by the presentation page information among the page data of a plurality of pages included in the data to PCs 300A to 300F operated by the participants, while when MFP 100 receives requested page information from PC 300A which is a specific participant apparatus, it transmits requested page data specified by the requested page information to PC 300A. As to PC 300A as the specific participant apparatus, in response to acceptance of designation of requested page data, PC 300A transmits requested page information to MFP 100, and in response to reception of the requested page data, PC 300A displays the image of the presentation page data and the image of the requested page data at the same time. Because the image used for presentation by the presenter and the image other than the same are displayed simultaneously in PC 300A as the specific participant apparatus operated by the participant, the participant is able to hear the presentation while viewing the related image.

In PC 300A as the specific participant apparatus, the thumbnail generated by MFP 100 may be displayed as the image of the presentation page data. This allows the requested page data to be displayed in a large size.

Further, in PC 300A as the specific participant apparatus, the image of the presentation page data and the image of the requested page data may be displayed in the same size, which allows the participant to confirm the images of the presentation page and the requested page at the same time.

MFP 100 transmits a plurality of thumbnails corresponding respectively to a plurality of pages of page data to PCs 300A to 300F operated by the participants, as a plurality of pieces of identification information for identification of the plurality of pages of page data included in the data. PCs 300A to 300F in turn display the thumbnails for the plurality of pages of page data in a selectable manner, allowing the participants to check the thumbnails to designate a requested page.

In the case where display of the requested page data is disabled by display disable information, MFP 100 does not transmit the requested page data. This prevents the requested page data from being displayed on PCs 300A to 300F operated by the participants when the presenter does not want the requested page data to be displayed on PCs 300A to 300F.

Similarly, in the case where printing of the requested page data is disabled by printing disable information, MFP 100 disables printing of the requested page data. This prevents the requested page data from being printed in PCs 300A to 300F when the presenter does not want the requested page data to be printed.

When MFP 100 as the data processing apparatus receives the presentation page information from PC 300 as the presenter apparatus operated by the presenter among PCs 300 and 300A to 300F, MFP 100 transmits a first screen including the image of the page data specified by the presentation page information to PCs 300A to 300F operated by the participants. When MFP 100 receives the requested page information from PC 300A as a specific participant apparatus among PCs 300A to 300F, it transmits a second screen including the image of the presentation page data specified by the presentation page information and the image of the requested page data specified by the requested page information to the specific participant apparatus. Accordingly, in PC 300A as the specific participant apparatus operated by the participant, the image the presenter is using for presentation and the image other than the same are displayed simultaneously, allowing the participant to hear the presentation made by the presenter while viewing the related image.

While MFP 100 has been described as an example of the image transmission apparatus in the above embodiment, the present invention may of course be understood as an image transmission method for carrying out the display control processing illustrated in FIGS. 11-13 or FIGS. 15-17 and, or an image transmission program for causing a computer to carry out the image transmission method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A conference system including a plurality of display apparatuses and a data processing apparatus operatively connectable with the plurality of display apparatuses, the display apparatuses including a presenter apparatus operated by a presenter and one or more participant apparatuses other than said presenter apparatus operated by corresponding one or more participants,
said data processing apparatus comprising:
a data obtaining portion to obtain data including page data for a plurality of pages;
a presentation page receiving portion to receive, from said presenter apparatus, presentation page information for identification of one of the page data for the plurality of pages included in said obtained data;
a presentation page transmitting portion to extract presentation page data specified by said received presentation page information from among the page data for the plurality of pages included in said data and transmit said extracted presentation page data to said one or more participant apparatuses;
a requested page receiving portion to receive, from a specific participant apparatus among said one or more participant apparatuses, requested page information for identification of one of the page data for the plurality of pages included in said obtained data; and
a requested page transmitting portion, in response to reception of said requested page information, to extract requested page data specified by said requested page information from among the page data for the plurality of pages included in said data and transmit said extracted requested page data to said specific participant apparatus; and
said plurality of display apparatuses each comprising:
a designation accepting portion to accept designation of said requested page data;
a requesting portion to transmit said requested page information for identification of said designated requested page data to said data processing apparatus; and
a display control portion, in response to reception of said requested page data, to display an image of said presentation page data and an image of said requested page data at the same time.

2. The conference system according to claim 1, wherein
said data processing apparatus further comprises:
a thumbnail generating portion to generate a plurality of thumbnails corresponding to images reduced in size of the page data for the plurality of pages included in said data; and
a thumbnail transmitting portion to transmit said generated thumbnails to said one or more participant apparatuses; and
said display control portion includes a thumbnail display portion, in response to reception of said requested page data, to display a thumbnail of said presentation page data and the image of said requested page data at the same time.

3. The conference system according to claim 2, wherein said thumbnail display portion displays the thumbnail of said presentation page data and a plurality of thumbnails of the pages preceding and succeeding the presentation page in a row, and displays the thumbnail of said presentation page data in a display manner different from the display manner of the other thumbnails.

4. The conference system according to claim 1, wherein
said display control portion includes
a requested page display portion to display the image of said requested page data, and
a presentation page display portion to display the image of said presentation page data in a same size as the image of said requested page data.

5. The conference system according to claim 1, wherein
said data processing apparatus further comprises an identification information transmitting portion to transmit a plurality of pieces of identification information for identification of the respective page data for the plurality of pages included in said data to said one or more participant apparatuses, and
in each of said one or more participant apparatuses,
said display control portion includes an identification information display portion to display said plurality of pieces of identification information, and
said designation accepting portion accepts designation of one of said plurality of pieces of identification information displayed.

6. The conference system according to claim 5, wherein
said data processing apparatus further comprises a thumbnail generating portion to generate a plurality of thumbnails corresponding to images reduced in size of the page data for the plurality of pages included in said data, and
each of said plurality of pieces of identification information includes the thumbnail of the corresponding page.

7. The conference system according to claim 1, wherein
said data includes display disable information for specifying page data for which display is disabled, and
said data processing apparatus further comprises a transmission disabling portion to disable transmission of said requested page data by said requested page transmitting portion in the case where said display disable information indicates that display of said requested page data is disabled.

8. The conference system according to claim 1, wherein
said data includes printing disable information for specifying page data for which printing is disabled, and
said data processing apparatus further comprises a printing disabling portion to disable printing of said presentation page data or said requested page data in the case where said printing disable information indicates that printing of said presentation page data or said requested page data is disabled.

9. The conference system according to claim 1, wherein said data processing apparatus further comprises a data receiving portion to receive said data from said presenter apparatus.

10. A data processing apparatus operatively connectable with a plurality of display apparatuses, the display apparatuses including a presenter apparatus operated by a presenter and one or more participant apparatuses other than said presenter apparatus operated by corresponding one or more participants, the data processing apparatus comprising:
a data obtaining portion to obtain data including page data for a plurality of pages;
a presentation page receiving portion to receive, from said presenter apparatus, presentation page information for identification of one of the page data for the plurality of pages included in said obtained data;
a first transmitting portion to transmit a first screen including an image of presentation page data specified by said received presentation page information among the page data for the plurality of pages included in said data to said one or more participant apparatuses;
a requested page receiving portion to receive, from a specific participant apparatus among said one or more participant apparatuses, requested page information for identification of one of the page data for the plurality of pages included in said obtained data;
a screen generating portion, in response to reception of said requested page information, to generate a second screen including an image of the requested page data specified by said requested page information among the page data for the plurality of pages included in said data and the image of the presentation page data specified by said presentation page information; and
a second transmitting portion to transmit said generated second screen to said specific participant apparatus.

11. The data processing apparatus according to claim 10, further comprising a thumbnail generating portion to generate a plurality of thumbnails corresponding to images reduced in size of the page data for the plurality of pages included in said data, wherein
said second screen includes a thumbnail of said presentation page data and the image of said requested page data.

12. The data processing apparatus according to claim 11, wherein said second screen includes a plurality of thumbnails corresponding respectively to said presentation page data and the page data preceding and succeeding the presentation page data, the thumbnail of the presentation page data being different in display manner from the other thumbnails.

13. The data processing apparatus according to claim 10, wherein said second screen includes the image of said presentation page data and the image of said requested page data identical in size to each other.

14. The data processing apparatus according to claim 10, wherein said first screen includes a plurality of pieces of identification information for identification of the respective page data for the plurality of pages included in said data.

15. The data processing apparatus according to claim 14, further comprising a thumbnail generating portion to generate a plurality of thumbnails corresponding to images reduced in size of the page data for the plurality of pages included in said data, wherein
each of said plurality of pieces of identification information includes a thumbnail of the corresponding page data.

16. The data processing apparatus according to claim 10, wherein
said data includes display disable information for specifying page data for which display is disabled, and
said data processing apparatus further comprises a transmission disabling portion to disable generation of said second screen by said screen generating portion in the case where said display disable information indicates that display of said requested page data is disabled.

17. The data processing apparatus according to claim 10, wherein
said data includes printing disable information for specifying page data for which printing is disabled, and
said data processing apparatus further comprises a printing disabling portion to disable printing of said presentation page data or said requested page data in the case where said printing disable information indicates that printing of said presentation page data or said requested page data is disabled.

18. An image transmission method, comprising the steps of:
obtaining data including page data for a plurality of pages;
receiving, from a presenter apparatus among a plurality of display apparatuses, presentation page information for identification of one of the page data for the plurality of pages included in said obtained data;
transmitting, to one or more participant apparatuses other than said presenter apparatus among said plurality of display apparatuses, a first screen including an image of presentation page data specified by said received presentation page information among the page data for the plurality of pages included in said data;
receiving, from a specific participant apparatus among said one or more participant apparatuses, requested page information for identification of one of the page data for the plurality of pages included in said obtained data;
in response to reception of said requested page information, generating a second screen including an image of requested page data specified by said requested page information among the page data for the plurality of pages included in said data and the image of the presentation page data specified by said presentation page information; and
transmitting said generated second screen to said specific participant apparatus.

19. An image transmission program embodied on a computer readable medium, causing a computer to carry out the steps of:
obtaining data including page data for a plurality of pages;
receiving, from a presenter apparatus among a plurality of display apparatuses, presentation page information for identification of one of the page data for the plurality of pages included in said obtained data;
transmitting, to one or more participant apparatuses other than said presenter apparatus among said plurality of display apparatuses, a first screen including an image of presentation page data specified by said received presentation page information among the page data for the plurality of pages included in said data;
receiving, from a specific participant apparatus among said one or more participant apparatuses, requested page information for identification of one of the page data for the plurality of pages included in said obtained data;
in response to reception of said requested page information, generating a second screen including an image of requested page data specified by said requested page information among the page data for the plurality of pages included in said data and the image of the presentation page data specified by said presentation page information; and
transmitting said generated second screen to said specific participant apparatus.
